(19) United States
(12) Patent Application Publication
(10) Pub. No.: US 2005/0008921 A1
(43) Pub. Date: Jan. 13, 2005

(54) Fluid flow plate for fuel cell

(75) Inventor: Thomas Johnson, Fairbanks, AK (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: University of Alaska Fairbanks

(21) Appl. No.: 10/889,941

(22) Filed: Jul. 12, 2004

Related U.S. Application Data
(60) Provisional application No. 60/485,910, filed on Jul. 10, 2003.

(51) Int. Cl. H01M 8/02

(52) U.S. Cl. 429/34; 429/38

(57) ABSTRACT

In a fuel cell (20) of the type having an electrolyte (22) and a fluid flow structure (24 and 26), the fluid flow structure includes a structure (24) having at least two surfaces (42 and 44). The fluid flow structure includes a first inlet (60) on the first surface, a first outlet (160) on the second surface, and a first channel (50) extending between the first inlet and the first outlet. The fluid flow structure further includes a second inlet (170) on the second surface, a second outlet (70) on the first surface, and a second channel (50) extending between the second inlet and the second outlet.

### CROSS-REFERENCE TO RELATED APPLICATION

This application claims the benefit of U.S. Provisional Application No. 60/485,910, filed Jul. 10, 2003, the disclosure of which is hereby expressly incorporated by reference.

### FIELD OF THE INVENTION

This invention relates generally to fuel cells, and more specifically to fluid flow structures within fuel cells and methods of using fluid flow structures for reactant delivery.

### BACKGROUND OF THE INVENTION

Fuel cells convert a fuel, such as hydrogen, and an oxidant, suitably oxygen, to electricity, heat, and reaction products. A fuel cell typically includes an electrolyte and electrodes in electrical contact with the electrolyte. In addition to providing electrical contact, the electrodes also serve to distribute reactants to the electrolyte and are sometimes referred to as collector plates, interconnects, flow fields, or flow plates. Depending on the design of the fuel cell, the fuel cell may also contain cooling plates. Further, there may be a layer of gas diffusion media or other material between the flow plates and the electrolyte. In most applications, a plurality of fuel cells are stacked in series to produce a desired voltage or power output.

Most of the prior art fluid flow plates, such as grid, channel, meander, and inter-digited varieties, share a common trait: long coplanar grooves. The fluid flow plate delivers reactants to the electrolyte, while simultaneously conducting electricity and heat, and removing inert gases and by-products. As a stream of mixed gas travels through a long groove, which forms a reaction channel when in contact with the electrolyte, reactants are consumed, and the concentration of reactants decreases. Once the stream of mixed gas reaches the end of the groove, the concentration of reactants is generally significantly reduced, producing a concentration gradient between the entrance to the groove and the exit from the groove.

In proton exchange membrane fuel cells (PEMFCs), in which the electrolyte is a membrane, a concentration gradient over the length of the groove causes two significant problems. First, at a given voltage, the efficiency of a fuel cell is related to the concentration of the reactants. A higher concentration of reactants yields higher fuel cell efficiency. Because of the concentration gradient, the portion of the membrane in contact with these depleted reactants runs less efficiently. To minimize these effects, excess reactants are used to ensure a high concentration of reactants at the end of the long coplanar channels.

Second, is the issue of membrane lifetime. The membrane can suffer irreversible damage if it is allowed to dry out. Because of the concentration gradient, portions of the membrane do a disproportionate share of work and, therefore, operate at a higher temperature than the average fuel cell temperature. These spots of high temperature cause localized drying, ultimately drying and damaging the membrane. The damaged portion of the membrane stops functioning, thereby reducing the active area of the membrane. The remaining active area of the membrane must work harder to produce the same power, and the problems cascade.

The concentration gradient also causes significant problems in solid oxide fuel cells (SOFCs). SOFCs are very susceptible to thermally induced stress. Just as described for PEMFCs, the uneven distribution of reactants can lead to hotspots or a thermal gradient across the electrolyte. These thermal gradients can lead to differential expansion, warpage, sealing problems, and breakage of the solid oxide electrolyte.

Thus, there exists a need for an improved method of reactant distribution that efficiently distributes reactants at a substantially constant concentration, without significantly increasing the cost of the fuel cell.

### SUMMARY OF THE INVENTION

In a fuel cell of the type having an electrolyte and a fluid flow structure, the fluid flow structure includes a structure, such as a plate, having at least two surfaces. The fluid flow plate includes a first inlet on the first surface, a first outlet on the second surface, and a first channel extending between the first inlet and the first outlet. The fluid flow plate further includes a second inlet on the second surface, a second outlet on the first surface, and a second channel extending between the second inlet and the second outlet.

In one embodiment, the fluid flow structure includes at least one entrance groove disposed on the first surface. In another embodiment, the fluid flow structure includes at least one exhaust groove disposed on the first surface. In another embodiment the entrance and exhaust grooves are radially disposed on the first surface. In yet another embodiment, the first inlet is disposed within the entrance groove, and the second outlet is disposed within the exhaust groove.

In another embodiment, each entrance and exhaust groove has a fluid flow area that is different at least in part from one end of the groove to the other end of the groove. In another embodiment, the entrance and exhaust grooves slope.

In another embodiment, the fluid flow structure further includes a plurality of inlets and outlets disposed on the first and second surfaces. In still yet another embodiment, at least a portion of fluid introduced to the fluid flow structure flows into the first inlet, out the first outlet, into the second inlet, and exhausts through the second outlet.

In another embodiment, the fluid flow structure includes a reaction cavity disposed on the second surface. In certain embodiments, the first outlet and the second inlet are disposed within the reaction cavity. In yet another embodiment, the reaction cavity is radially disposed on the second surface. In still yet another embodiment, at least a portion of the fluid flows through the reaction cavity.

In another embodiment, the fluid flow structure includes means for channeling fluid from the first surface to the second surface, means for channeling fluid from the second surface back to the first surface. In yet another embodiment, the fluid flow structure includes means for channeling fluid through the reaction cavity on the second surface.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isometric exploded view of the main components of an enlarged single cell fuel cell constructed in accordance with one embodiment of the present invention;

FIG. 2 is a top isometric view of a partial, enlarged fluid flow structure for the fuel cell of FIG. 1;

FIG. 3 is a bottom isometric view of a partial, enlarged fluid flow structure for the fuel cell of FIG. 1;

FIG. 4 is a bottom isometric partial cross-sectional view of a fluid path along the fluid flow structure for the fuel cell of FIG. 1;

FIG. 5 is a top isometric view of a partial, enlarged fluid flow structure formed in accordance with another embodiment of the present invention; and

FIG. 6 is a bottom isometric view of a partial, enlarged fluid flow structure formed in accordance with another embodiment of the present invention.

### DETAILED DESCRIPTION OF THE PREFERRED EMBODIMENT

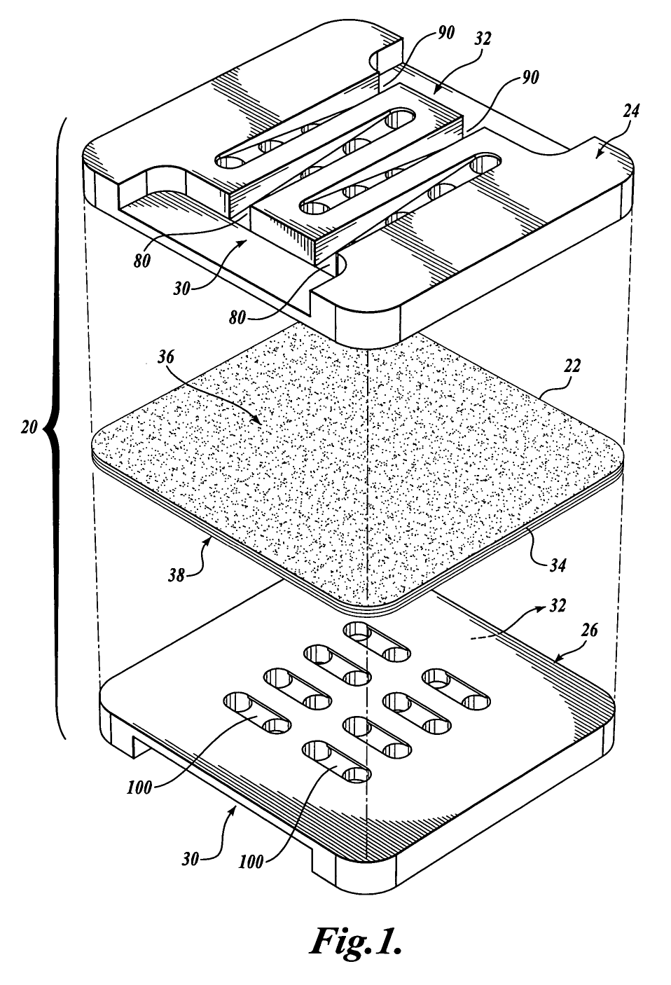

A fuel cell 20 having fluid flow structures 24 and 26 (hereinafter referred to as fluid flow plates) constructed in accordance with one embodiment of the present invention may be best understood by referring to FIG. 1. As used herein, the term “fluid flow structures” refers to plates, housings, boxes, or any other suitable structures having at least two surfaces.

Although the present embodiment is illustrated and described in conjunction with a specific type of fuel cell (namely, a PEMFC) the invention is not intended to be so limited. The fluid flow plate of the present invention may also be used in a wide variety of known fuel cells, including solid oxide fuel cells (SOFC), etc. Therefore, the present fuel cell is intended to be descriptive only, and not limiting.

The fuel cell 20 generally includes an electrolyte 22 and two fluid flow plates 24 and 26 surrounding the electrolyte 22. The fuel cell 20 and corresponding components of FIGS. 1-4 have been simplified and enlarged for clarity.

The electrolyte 22 includes a solid polymer electrolyte or ion exchange membrane 34 sandwiched between and in contact with first and second electrodes 36 and 38 made of porous, electrically conducting sheet material. The first electrode 36 is a cathode, and the second electrode 38 is an anode. The electrodes 36 and 38 are typically made from carbon or graphite fiber paper or cloth, or other materials known to one of ordinary skill in the art. A catalyst layer (not shown) is suitably disposed between the electrodes 36 and 38 and the ion exchange membrane 38 to facilitate an electrochemical reaction.

Additional fuel cells can be connected together in series to increase the voltage and power output. Such an arrangement is referred to as a fuel cell stack. The stack typically includes inlets, outlets, and manifolds for directing the flow of the reactants as well as coolant, such as water, to individual fluid flow plates.

Along the outer perimeter of the fluid flow plates 24 and 26 are inlet and outlet manifolds 30 and 32. In the illustrated embodiment of FIG. 1, the inlet and outlet manifolds 30 and 32 are suitably located at opposite ends (or sides) of the fluid flow plates 24 and 26. In a fuel cell stack having a plurality of fuel cells, the inlet and outlet manifolds 30 and 32 provide a relatively large cross-sectional area of fluid delivery to the fluid flow plates 24 and 26 to maintain a substantially constant fluid pressure at both manifolds 30 and 34 in a fuel cell stack having a plurality of fuel cells 20.

Suitable inlet and outlet manifolds 30 and 32 are further described in U.S. Pat. No. 5,879,826, issued to Lehman et al., the disclosure of which is hereby expressly incorporated by reference. Any other suitable manifolds, including manifolds that are not attached to the fluid flow plates 24 and 26, but instead are part of the fuel cell 20 structural support, as known by one of ordinary skill in the art, may be used in conjunction with the described embodiments of the present invention.

In the illustrated embodiment of FIG. 1, fluid flow plate 24 delivers oxidant to the first electrode 36 and fluid flow plate 26 delivers fuel to the second electrode 38 of the electrolyte 22. The term “fluids” as used herein, generally refers to both fuel and oxidant, as well as any other fluids.

Although fluid flow plates 24 and 26 deliver, respectively, oxidant and fuel to the first and second electrodes 36 and 38, the fluid flow plates 24 and 26, as illustrated and described herein, are structurally identical. In other fuel cell embodiments, the fluid flow plates may not be identical, for example, one fluid flow plate of the fuel cell may be in accordance with the present invention, and the other fluid flow plate may be structurally different. For brevity, the fluid flow plates are assumed to be identical and, therefore, only one fluid flow plate will be structurally described below.

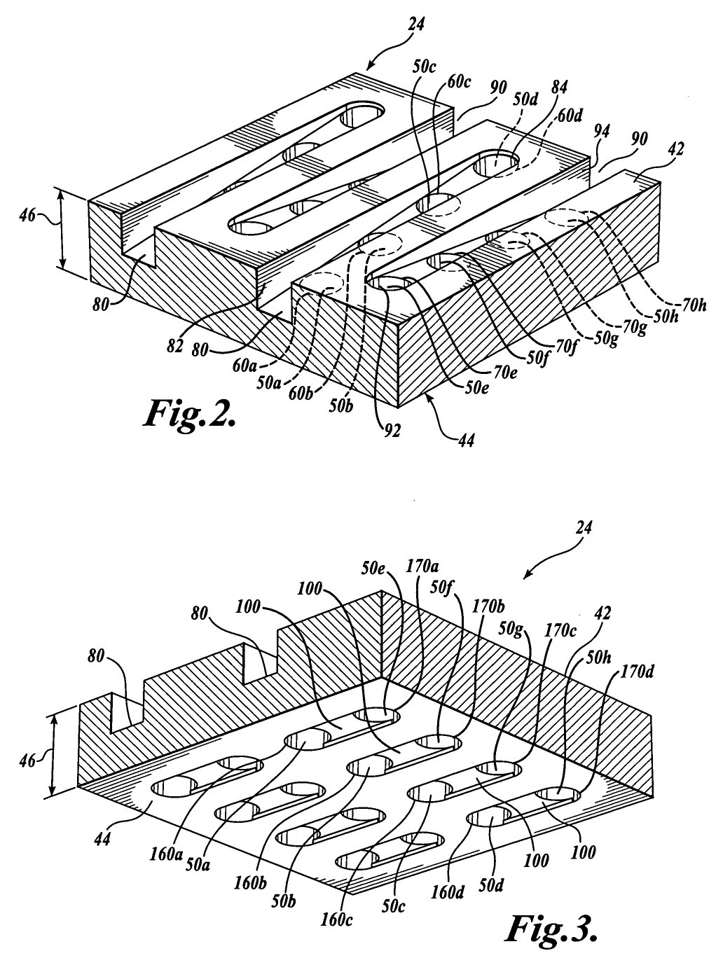

Referring to FIGS. 2 and 3, the fluid flow plates 24 and 26 will now be described in greater detail. The fluid flow plates 24 and 26 are suitably constructed from a material, such as graphite, carbon, or metals, including steel, steel alloys, or other suitable materials known to one of ordinary skill in the art. Fluid flow plate 24 includes first and second surfaces 42 and 44 held in spaced, parallel disposition by a thickness 46.

In the illustrated embodiment of FIG. 2, the first surface 42 includes two entrance grooves 80 and two exhaust grooves 90. The entrance and exhaust grooves 80 and 90 are formed within the fluid flow plate 24 by forming grooves into the first surface 42. The entrance and exhaust grooves 80 and 90 may be formed by cutting, machining, molding, etching, stamping, or any other suitable method of forming. In another embodiment, the fluid flow plate 24 may be formed by being built-up, i.e., by stacking a plurality of formed plates on top of one another.

Although a fluid flow plate 24 having two entrance and two exhaust grooves 80 and 90 is illustrated and described, it should be apparent that a fluid flow plate having more than two entrance and exhaust grooves, such as 20, 30, 100, 500, 1000, etc., is also within the scope of the present invention. In yet another embodiment of the present invention, the first surface 42 includes at least one entrance groove 80 and one exhaust groove 90 and, therefore, a fluid flow plate having less than two entrance and exhaust grooves is also within the scope of the present invention.

The entrance grooves 80 each have a first end 82 and a second end 84. The first ends 82 of the entrance grooves 80 are adjacent and in fluid communication with the inlet manifold 30 (FIG. 1). The second ends 84 of the entrance grooves 80 are near the outlet manifold 32 (FIG. 1), but the second ends 84 of the entrance grooves 80 are not necessarily in direct communication with the outlet manifold 32. Although not necessarily in direct fluid communication, the second ends 84 of the entrance grooves 80 are in indirect fluid communication with the outlet manifold 32 via channels 50, reaction cavities 100, and exhaust grooves 90.

The exhaust grooves 90 also each have a first end 92 and a second end 94. The first ends 92 of the exhaust grooves 90 are near inlet manifold 30, but not necessarily in direct fluid communication with the inlet manifold 30. Although not necessarily in direct fluid communication, the inlet manifold 30 is in indirect fluid communication with the first ends 92 of the exhaust grooves 90 via channels 50, reaction cavities 100, and entrance grooves 80. The second ends 94 of the exhaust grooves 90 are adjacent and in fluid communication with the outlet manifold 32.

In use, the first surface 42 of the fluid flow plate 24 abuts a closure panel (not shown). The closure panel, together with the entrance and exhaust grooves 80 and 90, forms a fluid flow area in each of the entrance and exhaust grooves 80 and 90. The fluid flow area is defined by a first surface of the closure panel and the respective entrance or exhaust grooves 80 and 90. Thus, the entrance and exhaust grooves 80 and 90 and inlet and outlet manifolds 30 and 32 form substantially closed fluid flow pathways within the fluid flow plate 24 when capped by the closure panel.

In one embodiment, the closure panel is a separate panel abutting the fluid flow plate 24. In another embodiment, the closure panel is integrally formed with or permanently attached to the fluid flow plate 24, either being welded or adhered to the fluid flow plate 24, or permanently attached by any other suitable method.

The fluid flow area in each of the entrance and exhaust grooves 80 and 90, preferably, is different at least in part along the length of the entrance and exhaust grooves 80 and 90. Still referring to FIG. 2, the entrance grooves 80 slope between the first and second ends 82 and 84. In particular, the entrance grooves 80 have a substantially constant slope from the first ends 82 to the second ends 84. As noted above, the second ends 84 of the entrance grooves 80 are substantially closed. As the entrance grooves 80 slope from the first ends 82 to the second ends 84, the fluid flow area decreases.

The exhaust grooves 90 are configured similarly to the entrance grooves 80, and each exhaust groove 90 includes a first end 92 and a second end 94. The exhaust grooves 90 also change with a substantially constant slope between their corresponding first and second ends 92 and 94. The first ends 92 of the exhaust grooves 90 are substantially closed. As the exhaust grooves 90 slope from the first ends 92 to the second ends 94, the fluid flow area increases.

Although the entrance and exhaust grooves 80 and 90 are illustrated and described as having a substantially constant slope or gradient, it should be apparent that non-constant slopes and substantially zero slopes are also within the scope of the present invention. In a non-limiting example, the entrance and exhaust grooves 80 and 90 have substantially no incline or decline, thus having a substantially constant fluid flow area.

In another non-limiting example, the entrance grooves 80 and the exhaust grooves 90 change by a series of steps. In yet another non-limiting example, the entrance grooves 80 and exhaust grooves 90 have a substantially constant groove depth, but narrow or widen in groove width. As the entrance grooves 80 narrow in groove width from the first ends 82 to the second ends 84, the fluid flow area decreases. As the exhaust grooves 90 widen in groove width from the first ends 92 to the second ends 94, the fluid flow area increases. As a result, entrance and exhaust grooves 80 and 90 having various geometrical configurations are within the scope of the present invention.

As may be best seen by referring to FIGS. 2-4, each fluid flow plate 24 includes a plurality of channels 50 extending between the first and second surfaces 42 and 44. As a non-limiting example, the fluid flow plate 24 includes sixteen channels 50. While the present embodiment is described as including a total of sixteen channels 50, it should be apparent that a fluid flow plate 24 having more (such as 20, 30, 100, 1000, 10,000, etc.) channels 50, or fewer (such as 2, 6, 10, etc.) channels 50 is also within the scope of the present invention.

In the illustrated embodiment of FIG. 2, each entrance groove 80 has four inlets 60a-60d in fluid communication with four corresponding channels 50a-50d. Similarly, each exhaust groove 90 includes four outlets 70e-70h in fluid communication with four corresponding channels 50e-50h.

As may be best seen by referring to FIG. 3, the second surface 44 of the fluid flow plate 24 includes a plurality of oblong-shaped reaction cavities 100 in fluid communication with a plurality of outlets 160a-160d and inlets 170a-170d. The oblong-shaped reaction cavities 100 are illustrated in FIGS. 1, 3, and 4 as a non-limiting example. In another non-limiting example, the reaction cavities may be circular. In yet another non-limiting example, the reaction cavities may be square or curvilinear. Thus, reaction cavities having various geometrical configurations are within the scope of the present invention.

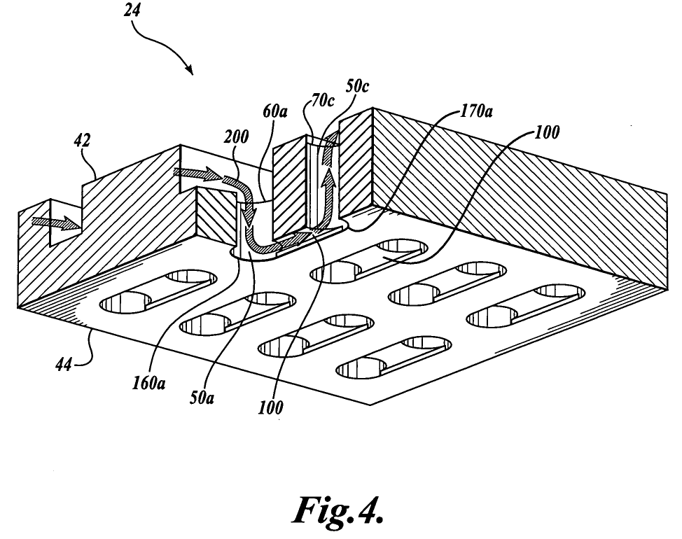

Now referring to FIG. 4, each reaction cavity 100 includes, for example, one outlet 160a and one inlet 170a. The outlet 160a is in fluid communication with the inlet 60a located within entrance groove 80 by the channel 50a. Similarly, the inlet 170a is in fluid communication with the outlet 70e located within the exhaust groove 90 by the channel 50e. As configured, a fluid flow pathway, illustrated by an arrow 200, is defined between inlet 60a and outlet 70e. All of inlets 60a-60d and outlets 70a-70d are identically configured and, therefore, will not be described for brevity.

In an alternate embodiment, the reaction cavities 100 can have a zero depth, such that fluid flows, for example, from outlet 160a of channel 50a directly to the electrolyte 22 (FIG. 1), and from the electrolyte 22 (FIG. 1) to inlet 170a of channel 50e.

Now referring to FIG. 2, as the fluid enters the first end 82 of the entrance groove 80, some of the fluid is diverted through the inlet 60a of the first channel 50a. Other fluid is diverted through the inlet 60b of the second channel 50b, the inlet 60c of the third channel 50c, and the inlet 60d of the fourth channel 50d. Because fluid is constantly being diverted through the plurality of channels 50a-50d, the slope of the entrance groove 80 from the first end 82 to the second end 84 maintains a substantially constant fluid velocity from the first end 82 to the second end 84 entrance groove 80.

Referring to FIG. 3 and the flow path of the fluid as depicted by arrow 200 in FIG. 4, fluid exits the plurality of channels 50a-50d at the channel outlets 160a- 160d into the reaction cavities 100. Fluid in channel 50a exits at outlet 160a. Fluid in channel 50b exits at outlet 160b, fluid in channel 50c exits at outlet 160c, and fluid in channel 50d exits at outlet 160d. As fluid exits channels 50a-50d at the channel outlets 160a-160d, the fluid flows into the plurality of reaction cavities 100.

The reaction cavities 100 provide fluid flow pathways. Fluid exits the plurality of reaction cavities 100 at inlets 170a-170d of channels 50e-50h. The fluid travels through channels 50e-50h, emerging in the exhaust groove 90 on the first surface 42 of the fluid flow plate 24 at the outlets 70e-70h of channels 50e-50h, and exiting through the exhaust groove 90 at the second end 94, and the outlet manifold 32. The slope of the exhaust grooves 90 from the first ends 92 to the second ends 4 maintains a substantially constant fluid velocity from the first ends 92 to the second end 94 the exhaust grooves 90.

As the fluid flows through the plurality of channels 50a-50d, a substantially constant concentration of fuel and oxidizing agent is introduced to the electrolyte 22 at the reaction cavities 100 and exhausted from the reaction cavities 100 after a predetermined period of exposure time based on the flow rates of the fluids. The reaction cavities 100 allow for a substantially constant concentration of fluid to react with the surfaces of the first and second electrodes 36 and 38 for a substantially equivalent period of time, creating a substantially constant reaction across the electrolyte 22. A substantially constant reaction across the electrolyte 22 decreases the thermal gradient across the electrolyte 22 thereby reducing the problems associated with thermal gradients, and increasing the overall efficiency of the fuel cell.

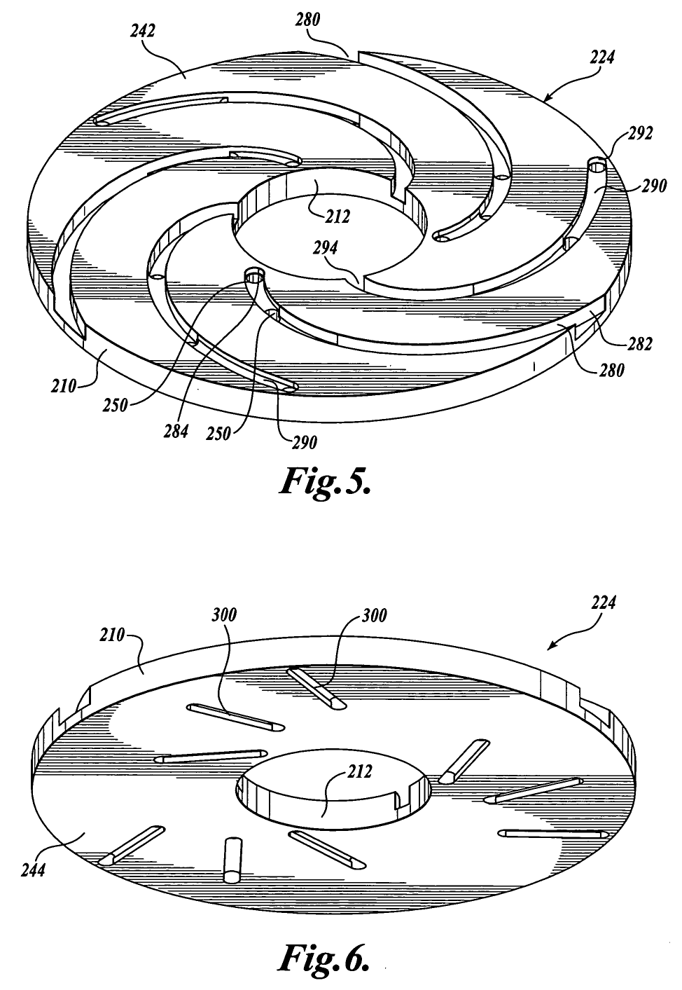

Referring to FIGS. 5 and 6, a second embodiment of the present invention will now be described. The materials, structure, operation, and properties of the second embodiment are identical to the first embodiment. The fluid flow plate 224, as illustrated in FIGS. 5 and 6, is a circular or disk-shaped structure having first and second surfaces 242 and 244. The first surface 242 of the fluid flow plate 224 includes entrance and exhaust grooves 280 and 290. The second surface 244 of the fluid flow plate 224 includes reaction cavities 300. The fluid flow plate 224 includes a plurality of channels 250 extending between the first and second surfaces 242 and 244.

The inlet and outlet manifolds (not shown) can be located in any suitable area along the outer perimeter 210 or inner edge 212, or both, of the fluid flow plate 224. In the illustrated embodiment, the inlet and outlet manifolds are, respectively, located substantially near the outer perimeter 210 and inner edge 212 of the fluid flow plate 224. In the illustrated embodiment, the first ends 282 of the entrance grooves 280 are in fluid communication with the inlet manifold (not shown) located at the outer perimeter 210 of the fluid flow plate 224.

The second ends 284 of the entrance grooves 280 are located near the outlet manifold (not shown) at the inner edge 212 of the fluid flow plate 224, but the second ends 284 of the entrance grooves 280 are not necessarily in direct fluid communication with the outlet manifold. Although not necessarily in direct fluid communication with the outlet manifold, the second end 284 of the entrance grooves 280 are in indirect fluid communication with the outlet manifold via the channels 250, reaction cavities 300, and exhaust grooves 290.

The first ends 292 of the exhaust grooves 290 are near the inlet manifold (not shown) of the fluid flow plate 224, but are not necessarily in direct fluid communication with the inlet manifold. Although not necessarily in direct fluid communication with the inlet manifold, the first ends 292 of exhaust grooves 290 are in indirect fluid communication with the inlet manifold via the entrance grooves 280, the channels 250. and the reaction cavities 300.

The second ends 294 of the exhaust grooves 290 are adjacent and in fluid communication with the outlet manifold (not shown) located at the inner edge 212 of the fluid flow plate 224. In the illustrated embodiment, the entrance and exhaust grooves 280 and 290 radially extend between first and second points located on the first surface 242 of fluid flow plate 224. The term “radially,” as used to describe this embodiment, includes an arcuate path, a straight path, or any other path.

In another non-limiting example, the entrance and exhaust grooves 280 and 290 and the reaction cavities 300 may extend in any portion of any line extending between two points located anywhere on the fluid flow plate 224.

In yet another non-limiting example, the inlet and outlet manifolds are, respectively, located at the inner edge 212 and the outer perimeter 210 of the fluid flow plate 224. In yet another non-limiting example, the fluid flow plate 224 has no inner edge 212 and the inlet and outlet manifolds are both located near the outer perimeter 210 of the fluid flow plate 224. In still another non-limiting example, the inlet and outlet manifolds are both located at the inner edge 212 of the fluid flow plate 224

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. In a fuel cell of the type having an electrolyte and a fluid flow structure, the fluid flow structure comprising:
(a) a structure having first and second surfaces;
(b) a first inlet on the first surface;
(c) a first outlet on the second surface;
(d) a first channel extending between the first inlet and the first outlet;
(e) a second inlet on the second surface;
(f) a second outlet on the first surface; and
(g) a second channel extending between the second inlet and the second outlet.

2. The fluid flow structure of claim 1, wherein the fluid flow structure is a fluid flow plate.

3. The fluid flow structure of claim 1, further comprising a first groove disposed on the first surface.

4. The fluid flow structure of claim 3, wherein the first inlet is disposed within the first groove.

5. The fluid flow structure of claim 4, wherein the first groove has first fluid flow area.

6. The fluid flow structure of claim 5, wherein the first groove has a second fluid flow area.

7. The fluid flow structure of claim 6, wherein the second fluid flow area is different at least in part from the first fluid flow area.

8. The fluid flow structure of claim 4, wherein the first groove has a first end and a second end, and wherein the first groove slopes from the first end to the second end.

9. The fluid flow structure of claim 1, further comprising a reaction cavity disposed on the second surface.

10. The fluid flow structure of claim 9, wherein the first outlet is disposed within the reaction cavity.

11. The fluid flow structure of claim 10, wherein the second inlet is disposed within the reaction cavity.

12. The fluid flow structure of claim 3, further comprising a second groove disposed on the first surface.

13. The fluid flow structure of claim 12, wherein the second outlet is disposed within the second groove.

14. The fluid flow structure of claim 13, wherein the second groove has a first fluid flow area.

15. The fluid flow structure of claim 14, wherein the second groove has a second fluid flow area.

16. The fluid flow structure of claim 15, wherein the second fluid flow area is different at least in part from the first fluid flow area.

17. The fluid flow structure of claim 13, wherein the second groove has a first end and a second end, and wherein the second groove slopes from the first end to the second end.

18. The fluid flow structure of claim 1, further comprising a plurality of inlets disposed on the first and second surfaces.

19. The fluid flow structure of claim 1, further comprising a plurality of outlets disposed on the first and second surfaces.

20. In a fuel cell of the type having an electrolyte and a fluid flow structure, the fluid flow structure comprising:
(a) a structure having first and second surfaces;
(b) an inlet on the first surface;
(c) an outlet on the second surface;
(d) means for channeling fluid from the first surface to the second surface; and
(e) means for channeling fluid from the second surface back to the first surface.

21. The fluid flow structure of claim 20, further comprising a reaction cavity located on the second surface.

22. The fluid flow structure of claim 21, wherein the reaction cavity is in fluid communication with the first outlet and a second inlet located on the second surface.

23. The fluid flow structure of claim 20, further comprising a plurality of inlets and outlets disposed on the first and second surfaces.

24. In a fuel cell of the type having an electrolyte and a fluid flow structure, the fluid flow structure comprising:
(a) a structure having first and second surfaces;
(b) a first inlet located on the first surface;
(c) a first outlet located on the second surface;
(d) a first channel extending between the first inlet and the first outlet;
(e) a second inlet located on the second surface;
(f) a second outlet located on the first surface;
(g) a second channel extending between the second inlet and the second outlet; and
(h) a reaction cavity disposed on the second surface, the reaction cavity providing a fluid flow pathway between at least the first outlet and the second inlet.

25. The fluid flow structure of claim 24, wherein the first outlet and the second inlet are disposed within the reaction cavity.

26. The fluid flow structure of claim 25, further comprising a first groove disposed on the first surface.

27. The fluid flow structure of claim 26, wherein the first inlet is disposed within the first groove.

28. The fluid flow structure of claim 26, further comprising a second groove disposed on the first surface.

29. The fluid flow structure of claim 28, wherein the second outlet is disposed within the second groove.

30. In a fuel cell of the type having an electrolyte and a fluid flow structure, the fluid flow structure comprising:
(a) a structure having first and second surfaces;
(b) a first groove disposed on the first surface;
(c) a first inlet disposed in the first groove;
(d) a first outlet located on the second surface;
(e) a first channel extending between the first inlet and the first outlet;
(f) a second inlet located on the second surface;
(g) a reaction cavity disposed on the second surface, wherein the first outlet and second inlet are disposed within the reaction cavity;
(h) a second groove disposed on the first surface;
(i) a second outlet disposed in the second groove on the first surface; and
(j) a second channel extending between the second inlet and the second outlet.

31. In a fuel cell of the type having an electrolyte and a fluid flow structure, the fluid flow structure comprising:
(a) a structure having first and second surfaces;
(b) a first inlet on the first surface;
(c) a first outlet on the second surface;
(d) a first channel extending between the first inlet and the first outlet;
(e) a second inlet on the second surface;
(f) a second outlet on the first surface; and
(g) a second channel extending between the second inlet and the second outlet, wherein at least a portion of fluid introduced to the fluid flow structure flows into the first inlet, out the first outlet, into the second inlet, and exhausts through the second outlet.

32. The fluid flow structure of claim 31, further comprising a reaction cavity disposed on the second surface.

33. The fluid flow structure of claim 32, wherein at least a portion of fluid flows through the reaction cavity.

34. The fluid flow structure of claim 32, wherein the first outlet and second inlet are disposed within the reaction cavity.

35. In a fuel cell of the type having an electrolyte and a fluid flow structure, the fluid flow structure comprising:
(a) a structure having first and second surfaces;
(b) a first groove radially disposed on the first surface;
(c) a first inlet disposed in the first groove;
(d) a first outlet located on the second surface;
(e) a first channel extending between the first inlet and the first outlet;
(f) a second inlet located on the second surface;
(g) a second groove radially disposed on the first surface;
(h) a second outlet disposed in the second groove; and
(i) a second channel extending between the second inlet and the second outlet.

36. The fluid flow structure of claim 35, further comprising a reaction cavity radially disposed on the second surface.

37. The fluid flow structure of claim 36, wherein the first outlet and second inlet are disposed within the reaction cavity.
